(19) United States
(12) Patent Application Publication
(10) Pub. No.: US 2024/0018067 A1
(43) Pub. Date: Jan. 18, 2024

(54) STABILIZED PEROXIDE ROTATING DETONATION ROCKET ENGINE

(71) Applicant: VENUS AEROSPACE CORP, Houston, TX (US)

(72) Inventors: Eric Wernimont, Houston, TX (US); Andrew Duggleby, Houston, TX (US); Nick Cardwell, Houston, TX (US); Christian Bailey, Houston, TX (US)

(21) Appl. No.: 17/813,261

(22) Filed: Jul. 18, 2022

(51) Int. Cl. C06B 23/00; F02K 9/42; C06B 31/02; C06B 47/04

(52) U.S. Cl. CPC C06B 23/006; F02K 9/42; C06B 31/02; C06B 47/04

(57) ABSTRACT

Disclosed is a stabilized solution of 70% to 100% hydrogen peroxide containing an alkali phosphate as a stabilizer, a rocket propellant including a combustible fuel and oxidizer, wherein the oxidizer is a stabilized solution of 70% to 100% hydrogen peroxide, and a rocket having a fuel store, an oxidizer store and a rocket engine, wherein the oxidizer is a stabilized solution of 70% to 100% hydrogen peroxide.

### FIELD OF THE DISCLOSURE

The present disclosure relates to rocket engines, and more particularly to oxidizers for use in rocket engines. The disclosure has particular utility for oxidizers for use in rotating detonation rocket engines (RDREs), and will be described in connection with such utility, although other utilities including the use as oxidizer in conventional rocket engines is contemplated.

### BACKGROUND AND SUMMARY

Rotating Detonation Rocket Engines (RDREs) are engines using a form of pressure gain combustion, based on a detonation wave traveling around an annular channel or annulus. In detonative combustion, the process achieves supersonic flow to provide propulsion. RDREs theoretically are more efficient than conventional deflagrative combustion rocket engines.

In operation, fuel and oxidizer are injected into the channel, normally through small holes or slits, and detonation is initiated in the fuel/oxidizer mixture by an igniter. After the engine is started, the detonations are self-sustaining to maintain operation of the RDRE—that is, once deflagation ignites the fuel/oxidizer mixture, the energy released sustains the detonations or detonation wavefront in subsequent order. The products of detonation combustion expand out of the channel, and are further pushed out of the channel by incoming fuel and oxidizer, resulting in a propelling force capable of driving an aircraft or rocket at supersonic or hypersonic speed.

Fuels and oxidizers currently used with liquid fueled rocket engines must be stored separately from one another, and have limited storage lives. Liquid oxygen, ammonium perchlorate (AP), ammonium dinitramide (AND), ammonium nitrate (AN), hydrazinium nitroformate (HNF) and hexanitrohexaazaisowurtzitane (HNIW) may be used as oxidizers. Liquid oxygen is inherently incompatible with wooden rounds, or storage and use without additional fueling or ongoing servicing. Several other commonly used oxidizers are polluting. Hydrogen peroxide has an advantage in being an inherently green chemical. Catalytic decomposition of hydrogen peroxide releases 2.877 MJ of energy per 1 kg of hydrogen peroxide, and produces green products according to the following reaction:

H₂O₂→H₂O+½O₂

This reaction leads to generation of hot water steam and superheated oxygen. Mass-wise, 47% of the decomposition reaction products of hydrogen peroxide is oxygen, which makes its high oxygen concentration efficient for use as an oxidizer for various rocket fuels.

However hydrogen peroxide has not been suitable as an oxidizer in rocket engines designed for long duration storage (e.g., 5, 10, 20 years or more) applications without servicing such as in field-deployed missiles and storable drones.

In accordance with the present disclosure, we provide a highly stabilized hydrogen peroxide oxidizer for use with rockets including RDREs as well as a system for storing, handling and delivering fuel and oxidizer mixtures to rockets including RDREs. The rocket may thus qualify as a so-called “wooden” round, for long duration storage, i.e., years, and reliable operation at any time. More particularly, in accordance with the present disclosure, we provide a hydrogen peroxide oxidizer for use in a rocket including a RDRE, having mixed therein a stabilizer comprised of an alkali phosphate or a mixture of an alkali phosphate and an alkali stannate.

In one embodiment, sodium phosphate (dodecahydrate) Na₂HPO₄·12H₂O and sodium stannate Na₂SnO₃·3H₂O is used, although other alkali phosphates which when dissolved in water form phosphoric acid advantageously may be used.

In one embodiment the stabilizer comprises sodium phosphate (dodecahydrate) Na₂HPO₄ 12H₂O or sodium stannate Na₂SnO₃·3H₂O and is added to the anhydrous hydrogen peroxide in a weight ratio of more than 10:1,000,000 stabilizer to hydrogen peroxide, preferably approximately 100:1,000,000 stabilizer to hydrogen peroxide.

In another embodiment the stabilizer comprises sodium nitrate or nitric acid and is added to the anhydrous hydrogen peroxide in a weight ratio of more than 30:1,000,000 stabilizer to hydrogen peroxide, preferably approximately 300:1,000,000 stabilizer to hydrogen peroxide.

The present disclosure also provides a rocket propellant comprising a combustible fuel and oxidizer, wherein the oxidizer comprises a stabilized solution of 70% to 100% hydrogen peroxide and a rocket comprising a fuel store, an oxidizer store and a rocket engine, wherein the oxidizer comprises a stabilized solution of 70% to 100% hydrogen peroxide. In one embodiment the rocket engine is a rotating detonation rocket engine.

The present invention disclosure also provides a rocket designed for long term (5, 10, 20 years or more) storage, in which the oxidizer is stabilized hydrogen peroxide, and wherein the fuel store and/or the oxidizer store are connected to the rocket engine through explosive valves.

Preferably the stabilizer is added to 70% to 100% hydrogen peroxide oxidizer in the following concentrations:

| | |
|---|---|
| Stannate (Sn) | 32 ± 4 milligrams per liter |
| Phosphate (PO₄^{—}) | 29 ± 4 milligrams per liter |
| Sodium nitrate (NO₃⁻) or | 100 ± 20 milligrams per liter. |
| Nitric acid (NO₃⁻) | |

When both the phosphate and the stannate are used, they may be used in any ratio. Preferably however, when used together, the phosphate and stannate should be used in molar ratios of approximately 1 to 4 phosphate to stannate.

In addition to stabilizing the hydrogen peroxide oxidizer, the added benefit of our stabilizer is that the stabilized-oxidizer when mixed with the fuel delays or slows propellant reaction, thus reducing reaction kinetics. Slowing the propellant reaction permits us to reduce nozzle size of the RDRE, allowing for mixing of the fuel and oxidizing agent to occur earlier, which in turn permits us to reduce the size and weight of the combustion chamber in our RDRE.

Also, delaying propellant reaction permits us to pre-mix our fuel with the hydrogen peroxide oxidizer before it enters the detonation chamber of our rocket engines. This in turn results in higher detonation efficiencies, and permits us to employ more compact detonation chambers. The resulting delayed propellant reaction also gives us more flexibility in system design including variable mixing efficiency to control detonation location and/or timing. Also, in accordance with our disclosure we are able vary the amount of stabilizer added to the fuel/hydrogen peroxide oxidizer mixture during rocket engine operation to adjust detonation rates.

Since hydrogen peroxide is corrosive to many metals, the storage tanks and fittings for the hydrogen peroxide may be formed of stainless steel.

Our hydrogen peroxide fuel stabilizer also provides safety features including:
If stabilizer were to leak, the rocket engine system may provide an early warning sign of leaking, which in turn could provide an emergency evacuation signal, and also on-condition versus date-based expiration determination. Leakage could be detected, for example, by gas-phase absorption and reaction or chromatography. Sensors may be placed in the propellant and/or oxidizer tanks, or in compartments outside the oxidizer tank, and may be configured to detect:
   Hydrogen Peroxide
   Stabilizer,
   Products of decomposition of the fuel or oxidizer.
The sensors also may be configured to sense low or reducing levels of stabilizer in the hydrogen peroxide, and trigger the addition of stabilizer from a source stored on the rocket.

### BRIEF DESCRIPTION OF THE DRAWINGS

Further features and advantages of the present disclosure will be seen from the following description, taken in connection with the accompanying drawings, wherein:

FIG. 1 is a schematic diagram of an Rotating Detonation Rocket Engine (RDRE) in accordance with the present disclosure;

FIG. 2 is a plan view of the injection nozzle of the RDRE of FIG. 1; and

FIG. 3 is a block diagram of a RDRE in accordance with the present disclosure.

### DETAILED DESCRIPTION OF THE DISCLOSURE

As used herein the term “stabilized hydrogen peroxide solution” means 70% to 100% hydrogen peroxide that is stabilized against decomposition during storage. Also, as used herein 70% hydrogen peroxide means 70% by weight (i.e., 70% weight H₂O₂ & 30% weight H₂O solution.

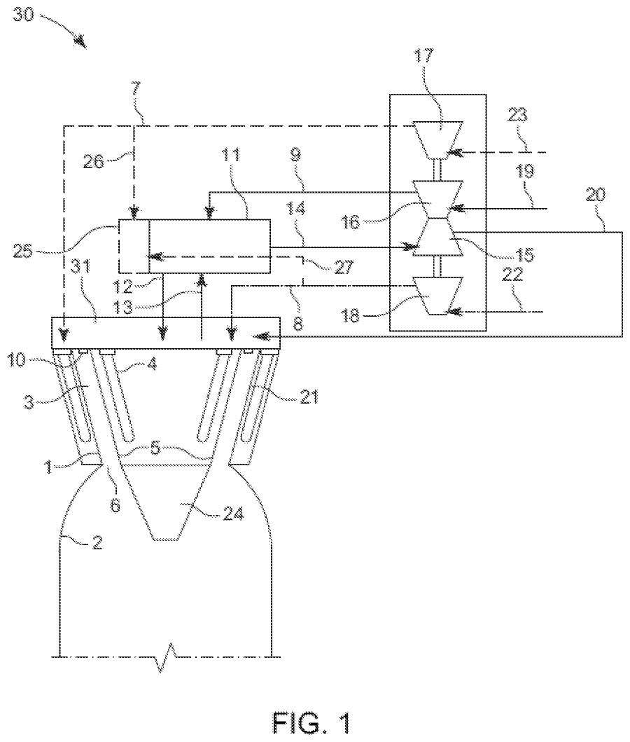

FIG. 1 illustrates the present invention in the form of an RDRE rocket engine 30 having a highly stabilized hydrogen peroxide oxidizer. A person or ordinary skill in the art understands that the schematic diagram shown in FIG. 1 is simplified so as not to obscure the invention with unnecessary detail. There are also a number of valves, ancillary lines, and by-pass pathways, not shown.

Referring to FIG. 1, the rocket engine 30 uses a propellant that includes a fuel source stored in the vehicle and delivered to the engine via the fuel feedline 23, a stabilized hydrogen peroxide oxidizer source stored in the vehicle and delivered to the engine via the oxidizer feedline 22, and a coolant source stored in the vehicle and delivered to the engine via the coolant feedline 19 which is in communication with a pressurization system consisting of a turbine 15, coolant pump 16, fuel pump 17, and oxidizer pump 18. The coolant pump 16 is in communication with a heat exchanger 11 via a high-pressure coolant line 9. The fuel pump 17 is in communication with the injector manifold 10 through a fuel high-pressure fuel line 7. The oxidizer pump 18 is in communication with the injector manifold 10 through a high-pressure oxidizer line 8.

The coolant temperature is increased in the heat exchanger 11 to a supercritical state and the supercritical coolant is then in communication with coolant channels, also called cowls, built into the outer walls via the coolant heat exchanger outlet line 12. In one embodiment, the supercritical state is temperature and pressure just into the supercritical regime of the coolant used. For example, if water is used as the supercritical coolant, the temperature may be raised to between 374-392° C., and the pressure to between 220-231 bar. The coolant may thus be raised to a just-supercritical state, just above the critical pressure and temperature, where there is a significant increase in convective heat transfer due to the lower viscosity and higher conductivity of the fluid. The internal coolant channels are integrated into the wall via manifolds and passages as those skilled in the art are familiar with. The coolant cools the engine walls including the throat 6 and portion of the nozzle 2 before returning to the heat exchanger 11 via the hot coolant inlet 13. The coolant after exchanging heat with the incoming coolant, exits the heat exchanger 11 and enters the coolant turbine 15 via the hot coolant heat exchanger outlet 14. After the coolant provides the power for the pressurization system, the coolant enters the injector manifold 10 via the turbine outlet line 20, and enters the combustion chamber 3 with the fuel and propellant and exits the rocket engine through the throat 6.

The rocket engine includes an aerospike nozzle 24 such that combustion happens in an annulus 3 contained by an inner cowl or channel 5 and outer cowl 1. An aerospike nozzle may also be any altitude-compensating nozzle, for example a plug nozzle, expanding nozzle, single expansion ramp nozzle, stepped nozzle, expansion deflection nozzle, or extending nozzle. In one embodiment where the rocket engine with aerospike nozzle is a rotating detonation rocket engine and there is an increased yet localized heat load near the injection point, the coolant is brought to a near-supercritical state at the same location to augment cooling.

In the illustrated embodiment there are coolant channels 4 in the inner cowl 5 and coolant channels 21 in the outer cowl 1. Coolant from the heat exchanger outlet 12 first cools the inner cowl 5 via coolant channels 4 before returning to the heat exchanger 11 via the hot coolant heat exchanger inlet 13. The hot coolant after exchanging heat with the incoming coolant, exits the heat exchanger 11 and enters the coolant turbine 15 via the hot coolant heat exchanger outlet 14. After the coolant turbine 15 the coolant returns to the aerospike engine and cools the outer cowl 1 via coolant channels 21. The coolant channels 4 and 21 are integrated into the cowls via manifolds and passages as those skilled in the art are familiar with. After the coolant provides the power for the pressurization system, the coolant enters the injector manifold 10 via the turbine outlet line 20, and enters the combustion chamber annulus 3 with the fuel and propellant and exits the rocket engine through the throat 6.

The rocket engine optionally may include a preburner shown in phantom at 25 to add heat to the coolant, completely or temporarily, for example just for startup, replacing or contributing to a heat exchanger. A small amount of fuel is diverted to the preburner 25 from the high-pressure fuel line 7 via the fuel preburner inlet 26, and a small amount of oxidizer is diverted to the preburner from the high-pressure oxidizer line 8 via the oxidizer preburner inlet 27.

The preburner 25 powers the pressurization system and then is mixed with the rest of the coolant in the preburner 25 before powering the turbopump 15 via the turbine inlet line 28 before cooling the rocket engine via the engine coolant line 20. Coolant is fed from the coolant pump 16 through line 9 to the preburner 25.

Element 31 in drawings is a block of hardware that includes plumbing as necessary, as is known in the art.

To this point, the RDRE rocket engine as illustrated in FIG. 1 and as described above is similar to the RDRE rocket engine described in our copending U.S. application Ser. No. 17/561,623, filed Dec. 23, 2021, the contents of which are incorporated herein in their entirety by reference.

The propellant comprises a fuel which may comprise a low-vapor pressure fuel, such as but not limited to ammonia (NH₃), propane (C₃H₈), methane (CH₄), or any fuel having a vapor pressure sufficiently low that the fuel boils in response to the low pressure in mixing section 18.

The oxidizer comprises a stabilized 90% hydrogen peroxide (H₂O₂) wherein the stabilizer comprises 10 milligrams of sodium phosphate (Na₂HPO₄·12H₂O) per liter of hydrogen peroxide and 30 milligrams of sodium stannate (Na₂SnO₃·3H₂O) per liter of hydrogen peroxide, and {Sodium nitrate (NO₃⁻) or Nitric acid (NO₃⁻) 100±20 milligrams per liter}.

Referring in particular to FIG. 2, in an embodiment, rocket engine 30 comprises a plurality of nozzle structures 48 concentrically arranged. Each nozzle structure 48 includes an injection nozzle spray node having three concentric outlets including an outer annulus 80 configured for spraying fuel, a middle outlet 82 configured for spraying supercritical coolant, and an inner outlet 84 configured for spraying oxidizer.

As mentioned supra, a feature and advantage of the present disclosure is that the phosphate/stannate stabilizer when mixed with the peroxide delays or slows down propellant reaction. This in turn permits us to reduce the size, i.e., the diameter of the oxidizer injector holes or annuli 84. Thus, rather than use oxidizer injector holes of, for example, 0.1″ as in the case of our current RDRE rocket nozzle as illustrated in our co-pending U.S. application Ser. No. 17/561,521, filed Dec. 23, 2021, the contents of which are incorporated herein by reference, we are able to reduce the size of the oxidizer injection holes 84 to a diameter of 0.001″. Also, another feature and advantage of the subject disclosure is that the nature of the stabilized hydrogen peroxide permits us, in another embodiment, to mix the fuel and the oxidizer in the rocket engine manifold.

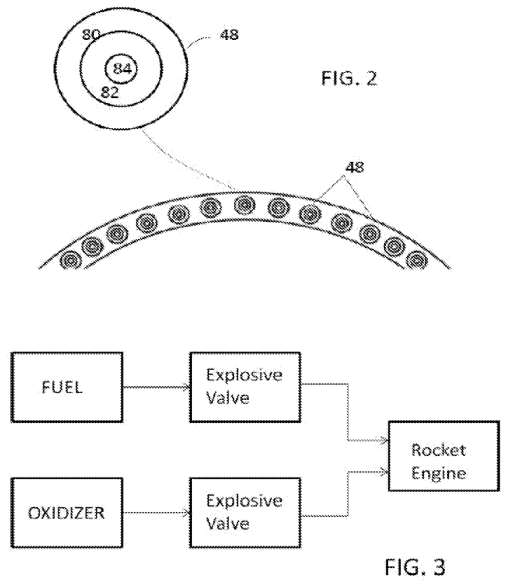

Referring also to FIG. 3, the stabilized hydrogen peroxide oxidizer permits long term storage, of a ready to fly rocket fueled with the stabilized hydrogen peroxide oxidizer and fuel such as missiles and drones. Hydrogen peroxide is short term compatible in terms of weeks with stainless steels but use of high stabilizers may permit longer term contact and storability, such is true of many other materials. However, even highly stabilized hydrogen peroxide is highly corrosive to many metals other than stainless steel, and stainless steel has significant drawbacks for use in a rocket engine including weight, machinability, and properties that make for good valves or pump parts. In order to enable long term storage of highly stabilized hydrogen peroxide without these drawbacks, in accordance with an embodiment of the disclosure, we provide an oxidizer storage system with an explosive activated valve between the oxidizer tank and downstream components. The valve may be such as is available from Mirion Technologies. Thus only the liner of the tank and explosive valve need be composed of a hydrogen peroxide-resistant material such as stainless steel, and the rest of the downstream valves and pumps may be made from more optimized materials. In addition, while most flow valves are functionally reliable over relatively short time periods, it is important in valves used, for example, in a stored missile to reliably function after many years storage. Since it is not possible to periodically test a valve under long term storage conditions, without potentially detonating a fuel, the importance of a valve reliably functioning after long term storage cannot be understated.

An additional benefit of the present invention is that hydrogen peroxide may be used without the need for catalyst bed because the RDRE uses its shock wave to separate oxygen from hydrogen peroxide. Yet another benefit is that oxidizer and fuel pre-mix fully and can be heated without harmful deflagration before detonation.

Various changes and advantages may be made in the above disclosure without departing from the spirit and scope thereof. In example, while the foregoing disclosure depicts the rocket engine as being a Rotating Detonation Rocket Engine (RDRE), the stabilized hydrogen peroxide oxidizer of the present disclosure also advantageously may be used in connection with other rocket engines including but not limited to Oblique Detonation Rocket Engines (ODREs), such as described in our copending U.S. application Ser. No. 17/828,868, filed May 31, 2022 (Attorney Docket No. 18875-000003US), the contents of which are incorporated herein in their entirety.

What is claimed:

1. A stabilized solution of 70% to 100% hydrogen peroxide containing an alkali phosphate as a stabilizer.

2. The stabilized solution of claim 1, wherein the alkali phosphate comprises sodium phosphate.

3. The stabilized solution of claim 2, wherein the sodium phosphate comprises NaₛHPO₄·12H₂O.

4. The stabilized solution of claim 1, further comprising an alkali stannate.

5. The stabilized solution of claim 4, wherein the alkali stannate comprises sodium stannate.

6. The stabilized solution of claim 5, wherein the sodium stannate comprises Na₂SnO₃·3H₂O.

7. The stabilized solution of claim 1, wherein the stabilizer is added to the hydrogen peroxide in a weight ratio of 30:1,000,000, to 300:1,000,000 stabilizer to hydrogen peroxide.

8. The stabilized solution of claim 1, further comprising sodium nitrate in a weight ratio of 10:1,000 to 100:1,000,000 sodium nitrate to hydrogen peroxide.

9. The stabilized solution of claim 1, further comprising nitric acid in a weight ratio of 10:1,000,000 to 100:1,000,000 nitric acid to hydrogen peroxide.

10. A rocket propellant comprising a combustible fuel and oxidizer, wherein the oxidizer comprises a stabilized solution of 70% to 100% hydrogen peroxide as claimed in claim 1.

11. A rocket comprising a fuel store, an oxidizer store and a rocket engine, wherein the oxidizer comprises a stabilized solution of 70% to 100% hydrogen peroxide as claimed in claim 1.

12. The rocket of claim 11, wherein the rocket engine is a rotating detonation rocket engine or an oblique detonation rocket engine.

13. The rocket of claim 11, wherein the fuel store and/or the oxidizer store are connected to the rocket engine through explosive valves.

14. The rocket of claim 11, wherein the oxidizer store is held in a stainless steel tank.

15. The rocket of claim 11, wherein the oxidizer has a storage life in excess of 5 years, preferably 10 years, 20 years or more.
